(19) United States
(12) Patent Application Publication
(10) Pub. No.: US 2025/0390083 A1
(43) Pub. Date: Dec. 25, 2025

(54) DEVICE AND METHOD FOR RECOGNIZING CERTAIN PRODUCTION MEANS ON A PRODUCTION MACHINE

(71) Applicant: Pepperl+Fuchs SE, Mannheim (DE)

(72) Inventors: Martin Schmitt, Steinfeld (DE); Thomas Kühn, Mannheim (DE)

(73) Assignee: Pepperl+Fuchs SE, Mannheim, OT (DE)

(21) Appl. No.: 19/242,427

(22) Filed: Jun. 18, 2025

(30) Foreign Application Priority Data
Jun. 20, 2024 (EP) 24183422.5

(51) Int. Cl. G05B 19/418

(52) U.S. Cl. CPC G05B 19/4183; G05B 2219/33199

(57) ABSTRACT

A production machine for manufacturing or further processing of a product using various types of production means includes at least two spaced-apart production means holders. Each holder is configured to receive a specific type of production means. A respective production means being one of a plurality of production means of the specific type. An RFID reader is arranged or configured between the production means holders so as to receive a response signal from an RFID transponder attached to the production means. The RFID reader being configured or arranged such that the response signal is received with a different amplitude depending on which of the production means holders the production means is arranged.

### TECHNICAL AREA

The invention relates to production machines, and in particular to production machines which can use different types of production means, such as tools or consumables, at two spatially separated production means holders. The invention further relates to methods for arranging different production means in production means holders of a production machine. Furthermore, the present invention relates to a method for contactless localization of an identification element on a production means using a detection device.

### TECHNICAL BACKGROUND

To automatically recognize and identify the type of a selectable production means that is inserted into a production machine, the production machine is usually equipped with a detection device. The detection device is capable of recognizing an identification element on the production means and reading or reading out identification information from it.

The identification element is often designed as an electronically readable RFID transponder (RFID=Radio Frequency Identification Transponder). Typically, these RFID transponders are passive and are read using an RFID reader as a detection device. The RFID reader transmits an excitation signal in the form of a high-frequency electromagnetic field via a loop antenna, which the transponder receives using a receiver coil. The received excitation signal is modulated according to identification information stored in the RFID transponder. The modulated response signal can be detected by the RFID reader. The identification information in the response signal can be evaluated by the reader and made available to the production machine. A production means to which such an RFID transponder is attached can therefore be uniquely identified.

Depending on the type of production means detected, the operation of the production machine can be controlled, permitted or blocked.

If several similar production means can be used in corresponding production means holders of a production machine, an RFID reader is usually required to read the respective identification information of a production means in the corresponding production means holder. This represents a high component and design cost.

It is therefore the object of the present invention to provide a production machine with improved recognition of the type of production means used in production means holders, in which the realization effort for the recognition can be reduced.

### DISCLOSURE OF THE INVENTION

This object has been achieved by the production machine for manufacturing or processing a product using production means with different properties according to claim 1 and a method for operating a production machine according to the further independent claim.

Further embodiments are indicated in the dependent claims.

According to a first aspect, an arrangement for identifying one or more production means, each provided with an RFID transponder, is provided, comprising:
An RFID reader for arranging on the one or more production means, adapted to receive a response signal from each of the RFID transponders of the one or more production means and to detect the amplitude of the response signal;
a control unit which is configured to associate a production means with a production means holder in which it is arranged or to assign a type or identification to the production means depending on the amplitude of the respective response signal.

According to a further aspect, a use of the above arrangement in a production machine is provided, wherein the amplitude and an associated identification information of the respective response signal is detected by the RFID reader, wherein the amplitude of each of the response signals is associated with a production means holder of the production machine, wherein the production machine is operated depending on the type or the identification of the respective production means determined by the identification information, and depending on the associated production means holder.

According to a further aspect, there is provided a production machine for manufacturing or further processing a product using various types of production means; comprising:
At least two spaced-apart production means holders, each configured to receive a specific type of production means, the respective production means being one of several production means of the specific type;
An RFID reader arranged or configured between the production means holders to receive a response signal from an RFID transponder attached to the production means, wherein the RFID reader is configured or arranged such that the response signal is received with different amplitudes depending on in which of the production means holders the production means is arranged.

Production machines use production means to further process or manufacture a product. A production means can be a tool, such as a drill, a milling head or the like, and can also be a consumable or supply material, such as a liquid supply material, such as paint, lubricant or the like, or components to be installed, such as screws, staples, electronic components and the like. The components can be provided in corresponding transport devices, such as rollers or containers. Both tools and supply materials are arranged/inserted in corresponding holding devices of the production machine, i.e. production means holders, in order to be used by the production machine or fed to the manufacturing process carried out by the production machine. Similar tools and similar supply materials can have different properties, such as drills with different diameters, or liquid supply material, such as paints of different colors, or pieces of supply material on reels or spools, such as staple spools, reels, or rolls or the like.

In the case of production machines that can be configured with regard to production means used, an RFID transponder attached to the production means can be electronically detected in order to electronically identify the type of production means used and to control the operation of the production machine accordingly. The RFID transponder is encoded with information that clearly indicates the type of the corresponding production means to which it is attached. The RFID transponder can be recognized and read by an RFID reader. The RFID reader then forwards the read identification information to a control unit of the production machine.

Production machines often have several production means holders that are suitable for holding similar but not always identical production means. It is therefore conventionally necessary to provide an RFID reader at each position of a production means holder where a tool or a supply material can be inserted in order to read the corresponding RFID transponder on the production means and thus the type or type of production means used.

In the case of production machines with a large number of such production means holders for similar production means, i.e. e.g. a means of the same type of use but with several possible characteristics or properties, e.g. different drills of different sizes and/or for different materials, paints with different viscosities and/or colors, or different supply reels with different piece components, this requires an increased technical effort in order to recognize the current configuration of the production means used. Therefore, the above arrangement and production machine are proposed to provide only a single RFID reader for detecting two similar production means in corresponding production means holders, whereby the production means cannot be distinguished by the type of production means holder. In other words, the production means could also be inserted into the production means holders interchanged.

The production machine according to the invention uses the possibility of using an RFID reader to detect the arrangement of production means in and/or the occupancy of two adjacent production means holders and to determine a unique identification of the production means used, i.e. the tool used in each case or the supply material used in each case. For this purpose, an RFID reader can be positioned/arranged between two production means holders in such a way that the production means used in the production means holders with their respective RFID transponders leads to different reception amplitudes of the response signal when the identification information is read out.

The RFID reader can have a loop antenna arranged outside the center position, the center position being defined so that the RFID transponders on the production means have different distances from the loop antenna in a state inserted in the production means holders. In other words, the loop antenna of the RFID reader can be arranged outside the center position between the positions of the RFID transponders of the production means that are inserted or can be inserted into the corresponding production means holders.

The Manchester protocol is used to read an RFID transponder using a reader. For this purpose, a transmission/excitation signal of a specified frequency, e.g. 13.56 MHz, is sent via a loop antenna. This is received by a receiver coil in the transponder. A transponder logic modulates the received signal in accordance with identification information as specified in the Manchester protocol and sends this as a response signal to the RFID reader. The response signal is then evaluated in the RFID reader. If there are several RFID transponders in the reception range of the RFID reader, multitag-capable communication takes place, e.g. in accordance with ISO15693-3. The communication corresponds to short-range communication, whereby the amplitude of the received response signal depends on the distance between the loop antenna of the RFID reader and the antenna of the RFID transponder.

The RFID transponders are located at predefined positions in the production machine when the respective production means is arranged/inserted. The loop antenna is arranged in such a way that the response signal is received with a different signal strength for each production means when the RFID transponders of the inserted production means are read. As the distance to the RFID transponders of the production means is defined in the respective production means holder, it is possible to specify on which side of the loop antenna of the RFID reader the respective RFID transponder is located and therefore which type of production means is inserted in the respective production means holder.

Furthermore, it may be provided that the RFID reader has a loop antenna which is provided on one side with a shielding element which is suitable for attenuating the transmission and response signal, so that, due to signal attenuation, response signals from the RFID transponders on the production means in a state used in the production means have different signal strengths depending on the side of the loop antenna on which the RFID transponder of the corresponding response signal is arranged.

The loop antenna of the RFID reader can also be covered on one side with a conductive layer that has a sheet resistance that does not completely shield the RFID reception signal. This means that the central arrangement of the loop antenna of the RFID reader between the RFID transponders can also lead to different amplitudes of the response signal

Furthermore, it can be provided that the RFID reader is configured to detect the amplitude of the response signal and an associated identification information, whereby a control unit is configured to assign a production means to the production means in which it is used, depending on the amplitude of the response signal, and to operate the production machine depending on the type of the respective production means, which is determined by the identification information.

Depending on the amplitude or amplitudes of the response signal, a control unit of the production machine can then first recognize which of the production means holders is occupied, and if both sides are occupied, the individual RFID transponders of the production means can be read out by reading out the identification information of the RFID transponder serially one after the other. The amplitude of the respective response signal can be used to recognize an assignment of the identification information of the RFID transponder and the side in relation to the RFID reader on which the RFID transponder and thus the production means is located. In this way, a single RFID reader can be used to occupy at least two production means holders on a production machine and clearly identify the type of production means used.

According to a further aspect, there is provided a method of operating a production machine for manufacturing or processing a product using different types of production means, the production machine comprising at least two spaced apart production means holders each adapted to receive a particular type of production means, wherein the respective production means is one of a plurality of production means of the particular type and further comprises an RFID reader disposed or arranged between the production means holders so as to receive a response signal of an RFID transponder attached to the production means, wherein the RFID reader is constructed or arranged such that the response signal is received with different amplitude depending on in which of the production means holders the production means is disposed; with the following steps:
Detecting the amplitude of the response signal of one or more RFID transponders;
Assigning the response signal to the production means in the production means holder depending on the amplitude,
operating of the production machine depending on the type of the respective production means, which is determined by the identification information, and on the assigned production means holder.

### BRIEF DESCRIPTION OF THE DRAWINGS

Embodiments are described in more detail below with reference to the accompanying drawings in which:

FIG. 1 shows a schematic representation of a production machine as an example of a bag filling machine in which a filling product is packed in tubular bags; and

FIG. 2 shows a flow chart illustrating a process for operating the production machine.

### DESCRIPTION OF EMBODIMENTS

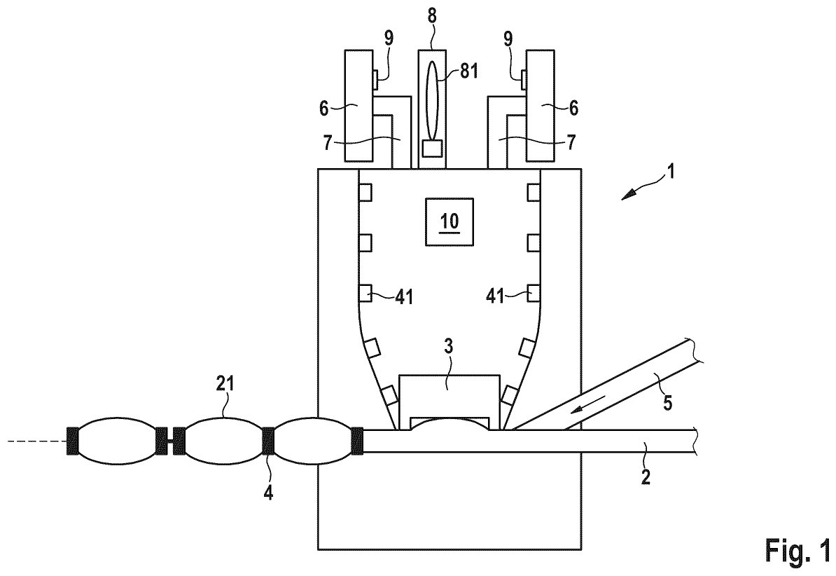

FIG. 1 schematically shows a bag filling machine 1 as a production machine that fills a product, for example food, a pasty material or the like, into a tubular section of a tube 2. The tube 2 is filled piece by piece and clamped on both sides of a filled portion using a tool 3 and a staple 4 in each case to create predefined bags 21 of a predefined size. Two staples 4 are provided between two bags 21 packed in this way in order to separate the bags 21 from each other by a subsequent separation process between the two staples 4.

For production, the filling material 5 and the tube 2 are fed to the bag filling machine 1.

Furthermore, staple blanks 41 are supplied for production as a production means, with which the ends of the bags 21 are clamped in order to seal them. Depending on the type of packaging, the staples 4 can be different at the two ends of a bag 21 to be produced. The staple blanks 41 are fed to the bag filling machine 1 via reels 6. The reels 6 each contain a roll with a tape on which the staple blanks 41 are attached or arranged. Two reel holders 7 (production means holders) can be provided as production means holders for the staple reels 6, which feed staple blanks 41 into the bag filling machine 1 accordingly. The reels 6 are rotatably attached to the respective reel holders 7 so that they can be unwound in order to feed the staple blanks 41 on the belt to the production process.

The bag filling machine 1 can generally process a variety of different types (sizes, shapes and/or materials) of staple blanks 41. The bag filling machine 1 can also provide different staples 4 for the beginning and the end of a bag and different staple blanks 41 for this purpose. An RFID reader 8 is arranged between the reel holders 7 of the bag filling machine 1. The RFID reader 8 has a receiving coil as a loop antenna 81 and a logic unit 82. The axial direction of the loop antenna 81 points in the direction of the staple reels 6 when these are arranged in the reel holder 7. The RFID reader 8 can be arranged with its loop antenna 81 in such a way that an RFID transponder 9 arranged on the staple reel 6 or applied to the side is at a different distance from the loop antenna 81.

The logic unit 82 is configured to provide a transmission signal. This is modulated by the RFID transponder 9 according to unique identification information and a modulated response signal is transmitted to the RFID reader 8. Since the signal strength depends on the distance between the loop antenna 81 and the RFID transponder, the modulated response signal is received with an amplitude that depends on the distance between the RFID reader 8 and the RFID transponder 9. Once the identification information has been received, it can be assigned to an amplitude and thus to a location of the respective staple reel 6. For example, the response signal of the staple reel 6 with the higher amplitude can be assigned to the left staple reel 6, while the response signal with the lower amplitude can be assigned to the right staple reel 6, as this has the greater distance from the loop antenna 81.

In this way, a single RFID reader 8 can recognize which of the reel holders 7 is occupied by a staple reel 6 (response signal received yes/no) and of what kind/type the staple reel 6 is (based on the identification information) and which identification information is assigned to the staple reel on the left and right reel holder 7 (based on the amplitude of the response signal to the corresponding identification information). The type of staple blanks 41 in the staple reel 6 is indicated by the identification information and is obtained by evaluating the modulated response signal according to the Manchester protocol, which is usually used for RFID readers.

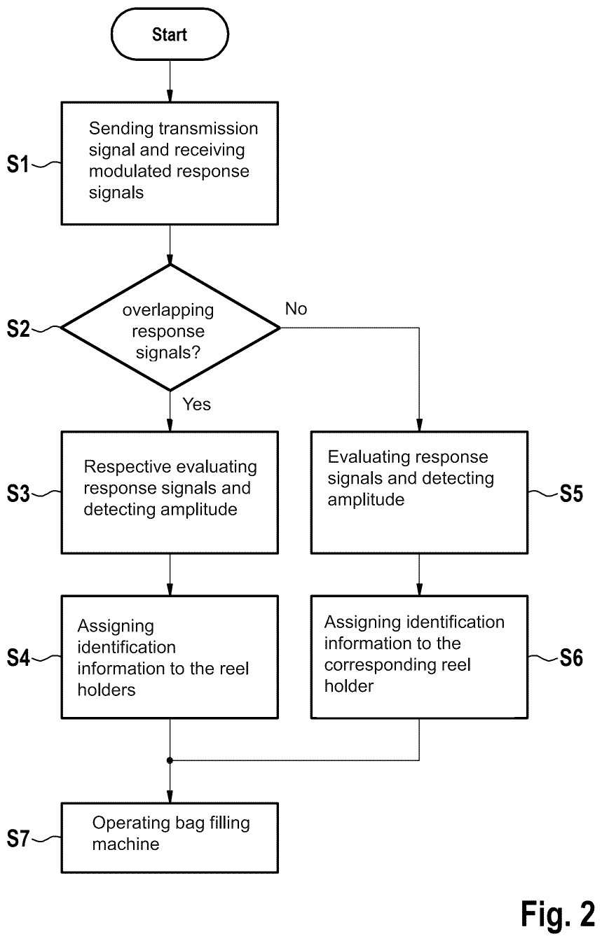

The bag filling machine 1 has a control unit 10 which controls the operation of the bag filling machine 1 according to a method illustrated by the flow diagram in FIG. 2.

First, at the start of operation of the production machine in step S1, a transmission signal is sent out using the RFID reader 8 and, if necessary, modulated response signals are received.

Step S2 checks whether overlapping modulated response signals have been received. If this is the case (alternative: yes), the RFID transponders 9 are addressed serially in step S3 in accordance with the Manchester protocol in order to receive only one modulated response signal at a time. The respective response signal is evaluated in order to obtain the identification information and the amplitude of the response signal is detected at the same time.

In step S4, the identification information is assigned to the amplitudes and it is determined in each case whether the amplitude is assigned to the smaller distance between RFID transponder 9 and RFID reader 8 or the greater distance. This allows the identification information to be clearly assigned to the respective reel holder 7.

If it is determined in step S2 that no superimposed modulated response signals were received, but only one single response signal (alternative: No), the response signal is evaluated in step S5 in order to obtain the identification information and the amplitude of the response signal is detected at the same time.

In step S6, the identification information is assigned to the amplitude and it is determined whether the amplitude is assigned to the smaller distance between RFID transponder 9 and RFID reader 8 or the greater distance. This allows the identification information to be clearly assigned to the respective reel holder 7.

In step S7, the control unit 10 is operated depending on the type of staple reel 6 identified by the identification information. By recognizing the reel holder 7 in which the respective staple reel 6 is arranged, it can be ensured that the control unit 10 operates the bag filling machine 1 in such a way that the processing process takes into account the type of staples 4.

In this way, the control unit 10 of the production machine can recognize which of the production means holders is occupied depending on the amplitude or amplitudes of the response signal, and if both sides are occupied, the individual RFID transponders 9 of the production means can be read out by reading out the identification information of the RFID transponders 9 serially one after the other.

1. An arrangement for identifying one or more production means, each of which is provided with an RFID transponder comprising:
An RFID reader for placement on the one or more production means, adapted to receive a response signal from each of the RFID transponders of the one or more production means and to detect the amplitude of the response signal; and
A control unit which is configured to assign to the production means, depending on the amplitude of the respective response signal, a production means holder in which it is used, or a type or identification of the production means.

2. Use of an arrangement according to claim 1 in a production machine, wherein the amplitude and an associated identification information of the respective response signal is detected by the RFID reader, wherein the amplitude of each of the response signals is associated with a production means holder of the production machine, wherein the production machine is operated depending on the type or the identification of the respective production means, which is determined by the identification information, and depending on the associated production means holder.

3. A production machine for the production or further processing of a product with the aid of various types of production means; comprising:
At least two spaced-apart production means holders, each configured to receive a specific type of production means, the respective production means being one of a plurality of production means of the specific type; and
An RFID reader which is arranged or configured between the production means holders so as to receive a response signal from an RFID transponder attached to the production means, the RFID reader being configured or arranged such that the response signal is received with a different amplitude depending on in which of the production means holders the production means is arranged.

4. The production machine according to claim 3, wherein the RFID reader has a loop antenna which is arranged outside the center position, the center position being defined so that the RFID transponders on the production means are at different distances from the loop antenna in a state inserted in the production means holders.

5. The production machine according to claim 3, wherein the RFID reader has a loop antenna which is provided on one side with a shielding element, wherein the shielding element in particular has a layer or structure with an electrical resistance, so that response signals from the RFID transponders on the production means have different signal strengths in a state inserted into the production means holders due to signal attenuation.

6. The production machine according to claim 3, wherein the production means comprises a tool or a supply material.

7. The production machine according to claim 3, wherein the RFID reader is configured to detect the amplitude of the response signal and an associated identification information, wherein a control unit is configured to assign a production means holder, in which this is inserted, to the production means depending on the amplitude of the response signal and to operate the production machine depending on the type of the respective production means, which is determined by the identification information.

8. A method of operating a production machine for manufacturing or processing a product using different types of production means, the production machine comprising at least two spaced apart production means holders each adapted to receive a particular type of production means, the respective production means being one of a plurality of production means of the particular type, and further comprising an RFID reader which is arranged or configured between the production means holders so as to receive a response signal from an RFID transponder attached to the production means, the RFID reader being configured or arranged such that the response signal is received with a different amplitude depending on in which of the production means holders the production means is arranged; with the following steps:
Detecting the amplitude of the response signal of one or more RFID transponders;
Assigning the response signal to the production means in the production means holder determined by the amplitude; and
Operation of the production machine depending on the type of the respective production means, which is determined by the identification information, and depending on the assigned production means holder.

9. The production machine according to claim 4, wherein the RFID reader has a loop antenna which is provided on one side with a shielding element, wherein the shielding element in particular has a layer or structure with an electrical resistance, so that response signals from the RFID transponders on the production means have different signal strengths in a state inserted into the production means holders due to signal attenuation.

10. The production machine according to claim 9, wherein the production means comprises a tool or a supply material.

11. The production machine according to claim 4, wherein the production means comprises a tool or a supply material.

12. The production machine according to claim 5, wherein the production means comprises a tool or a supply material.

13. The production machine according to claim 4, wherein the RFID reader is configured to detect the amplitude of the response signal and an associated identification information, wherein a control unit is configured to assign a production means holder, in which this is inserted, to the production means depending on the amplitude of the response signal and to operate the production machine depending on the type of the respective production means, which is determined by the identification information.

14. The production machine according to claim 5, wherein the RFID reader is configured to detect the amplitude of the response signal and an associated identification information, wherein a control unit is configured to assign a production means holder, in which this is inserted, to the production means depending on the amplitude of the response signal and to operate the production machine depending on the type of the respective production means, which is determined by the identification information.

15. The production machine according to claim 6, wherein the RFID reader is configured to detect the amplitude of the response signal and an associated identification information, wherein a control unit is configured to assign a production means holder, in which this is inserted, to the production means depending on the amplitude of the response signal and to operate the production machine depending on the type of the respective production means, which is determined by the identification information.

16. The production machine according to claim 9, wherein the RFID reader is configured to detect the amplitude of the response signal and an associated identification information, wherein a control unit is configured to assign a production means holder, in which this is inserted, to the production means depending on the amplitude of the response signal and to operate the production machine depending on the type of the respective production means, which is determined by the identification information.

17. The production machine according to claim 10, wherein the RFID reader is configured to detect the amplitude of the response signal and an associated identification information, wherein a control unit is configured to assign a production means holder, in which this is inserted, to the production means depending on the amplitude of the response signal and to operate the production machine depending on the type of the respective production means, which is determined by the identification information.
